(19) United States
(12) Patent Application Publication
(10) Pub. No.: US 2017/0226395 A1
(43) Pub. Date: Aug. 10, 2017

(54) THERMAL ENERGY STORAGE PHASE CHANGE MATERIALS COMPRISING BORONIC ACIDS AND METHODS OF MAKING AND USING THEM

(71) Applicant: Entropy Solutions, LLC, Plymouth, MN (US)

(72) Inventors: William Rusty SUTTERLIN, Hoover, AL (US); Andre WILLIAMS, Tuscaloosa, AL (US)

(21) Appl. No.: 15/502,997

(22) PCT Filed: Aug. 11, 2015
(86) PCT No.: PCT/US15/44741

§ 371 Date: Feb. 9, 2017

Related U.S. Application Data
(60) Provisional application No. 62/036,614, filed on Aug. 12, 2014.

(51) Int. Cl. C09K 5/06; F28D 20/02; E04C 2/284

(52) U.S. Cl. CPC C09K 5/063; E04C 2/284; F28D 20/02; B60R 13/08

(57) ABSTRACT

Provided are Phase Change Material (PCMs) compositions for thermal management in different applications such as building, automotive, airplane, truck, shipping, packaging, textile and food storage and transport applications. Provided are compositions comprising non-toxic molecules with enhanced PCM characteristics comprising boronic acids and equivalents, including for example, non-aromatic cyclic boronic acids, alkyl boronic acids, alkene boronic acids, arylboronic acids, and related compounds. In alternative embodiments, provided are thermal energy storage compositions, products of manufacture or systems comprising: a phase change material (PCM) composition comprising a boronic acid or boronic acid derivatives, wherein the PCM undergoes solid to liquid and liquid to solid phase change transitions.

### FIELD OF THE INVENTION

Provided are Phase Change Material (PCMs) compositions for thermal management in different applications such as building, automotive, industrial manufacturing, packaging, textile and food storage and transport applications. Provided are non-toxic molecules with enhanced PCM characteristics comprising boronic acids, boronic acid derivatives and equivalents, including for example, non-aromatic cyclic boronic acids, alkyl boronic acids, alkene boronic acids, arylboronic acids, and related compounds.

### BACKGROUND

There is a general desire in all industries to be energy efficient. There is also a general desire to reduce the use of fossil fuel resources due to concerns over climate change and energy security. Buildings, for example, require significant amounts of energy for heating and cooling and there is a need to reduce the costs associated with thermal management. The thermal management of temperature sensitive payloads during transport can also require significant amounts of energy. In the automotive industry, there is a desire to increase efficiency and reduce the fuel usage associated with maintaining a comfortable temperature in the cabin of vehicles. In the textile industry, in particular for life and personal protection clothing, there is a desire to create fabrics and materials that maintain the temperature of the wearer in a comfortable range by managing away excess heat.

One approach of decreasing the amount of energy needed for thermal management is the use of phase change materials. A “phase change material” (PCM) is a material that stores or releases a large amount of energy during a change in state, or “phase”, e.g. crystallization (solidifying) or melting (liquefying) at a specific temperature. The amount of energy stored or released by a material during crystallization or melting, respectively, is the latent heat of that material. During such phase changes, the temperature of the material remains relatively constant. This is in contrast to the “sensible” heat, which does result in a temperature change of the material, but not a phase change.

PCMs are therefore “latent” thermal storage materials. A transfer of energy occurs when the material undergoes a phase change, e.g. from a liquid to a solid and thus helps to maintain the temperature of a system. When heat is supplied to the system in which the temperature is at the melting point of the PCM, energy will be stored by the PCM, resulting in a mediating effect on the temperature of the system. Similarly, when the temperature of the system decreases to the crystallization temperature of the PCM, the energy stored by the PCM will be released into the surrounding environment. The amount of energy stored or released by a material is a constant, and is that material's latent heat value. For example, water has a latent heat of 333 J/g. Therefore, a gram of water will release 333 J of energy to its surrounding environment during crystallization (freezing), at 0° C. without changing temperature. Similarly, a gram of frozen water will absorb 333 J of energy from its surrounding environment during melting without an increase in temperature from 0° C.

There are two primary characteristics that must be considered for a specific application of a PCM: 1) the melting/crystallization temperature of the material, and 2) the latent heat value. A high latent heat value is the most desirable characteristic of a phase change material. A high latent heat value means that the material will be able to store or release large amounts of energy during a phase change, thus reducing the quantity of supplied energy needed to heat or cool a system. A latent heat value of 160 J/g or higher is considered acceptable for a PCM material in thermal storage applications. The melting/crystallization temperature is important because every thermal storage system has a unique optimal temperature range. These two factors together inform the potential applications for a specific PCM. For example, although water has a very high latent value (333 J/g), it would not be suitable for use as a PCM in building materials, as buildings are typically maintained at temperatures around 70° C., well above the melting/crystallization temperature of water.

The majority of commercially available PCMs are salt hydrates or paraffins. Both salt hydrates and paraffins have inherent disadvantages in commercial applications. Salt hydrates, while cheap to produce, have inconsistent melting points, and have a tendency to supercool. Salt hydrates are also known to undergo significant thermal expansion and can be highly toxic and corrosive. Paraffins make suitable PCMs in that they have favorable latent heat values and consistent melting points. However, the high latent heats of paraffin-based PCMs (in excess of 230 J/g) require compositions comprising high purities of paraffins, necessitating the use of expensive processing technology. Further, paraffins are limited in their potential range of phase change temperatures, leading to the use of mixed PCM compositions with reduced latent heat values.

Other concerns with paraffins used as PCMs are social dynamics. Paraffins are made from petroleum products, which increases our reliance on crude oil. Paraffin prices have followed the unstable price of petroleum. Furthermore, petroleum derived paraffins have geopolitical consequences and contribute to the increase in carbon emissions blamed for the global warming crisis.

The widespread use of traditional PCMs has been further limited due to concerns over flammability. For example, the use of paraffin or vegetable oil-derived PCMs has been limited due to the inherent flammability of many of these materials. A need thus remains for PCMs with high latent heat and other favorable thermal storage properties that can be used thermal energy storage systems across a broad range of temperatures.

### SUMMARY

In alternative embodiments, provided are thermal energy storage materials comprising a boronic acid or boronic acid derivative phase change material (PCM), e.g., a boronic acid or boronic acid derivative PCM with favorable PCM characteristics such as high latent heats, wherein the thermal energy storage material undergoes solid to liquid and liquid to solid phase change transitions. Provided are thermal energy storage materials and applications of the thermal energy storage materials, including for example: building materials e.g. walls, flooring and tank devices used to moderate climates in buildings, food storage coolers or other types of containers used to maintain a desired temperature during the in the transport and/or storage of food, textiles and other fabrics, automotive materials and systems used to manage thermal energy in automobiles, and essentially any device used to keep a substance at a relatively constant temperature between about 50° C. and 300° C. In alternative embodiments, provided are PCM compounds comprising a boronic acid, or boronic acid derivatives and/or equivalents, including for example, non-aromatic cyclic boronic acids, alkyl boronic acids, alkene boronic acids, arylboronic acids, and related compounds.

In alternative embodiments, provided are thermal energy storage compounds comprising a phase change material (PCM) compound comprising a boronic acid or boronic acid derivatives, wherein the thermal energy storage compound undergoes solid to liquid and liquid to solid phase change transitions.

In alternative embodiments, provided are thermal energy storage compositions, products of manufacture or systems comprising:

a phase change material (PCM) composition comprising a boronic acid or boronic acid derivatives, wherein the PCM undergoes solid to liquid and liquid to solid phase change transitions,

wherein optionally the boronic acid or boronic acid derivative is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM.

In alternative embodiments, the boronic acid or boronic acid derivative comprises a non-aromatic cyclic boronic acid selected from the group consisting of: a cyclohexylboronic acid, a neopentylboronic acid, a cyclopentylboronic acid, cyclobutylboronic acid, cyclopropylboronic acid, a cyclohexylboronic acid and any combination thereof.

In alternative embodiments, the boronic acid or boronic acid derivative comprises an alkyl boronic acid selected from the group consisting of: a methylboronic acid, a (methoxymethyl)boronic acid, an ethylboronic acid, an isopropylboronic acid, a 1-propylboronic acid, a (2-methylpropyl)boronic acid, a n-butylboronic acid, a sec-butylboronic acid, a tert-butylboronic acid, a 4-bromobutylboronic acid, a 1-pentylboronic acid, an isopentylboronic acid, a neopentylboronic acid, an n-hexylboronic acid, a 1,6-hexanediboronic acid, a n-heptylboronic acid, an 1-octylboronic acid, a n-nonylboronic acid, a 1-decylboronic acid, a n-dodecaneboronic acid, a n-hexadecaneboronic acid, an n-octadecaneboronic acid, a n-eicosaneboronic acid, a n-tricontaneboronic acid, a benzylboronic acid and any combination thereof.

In alternative embodiments, the boronic acid or boronic acid derivative comprises an alkene boronic acid selected from the group consisting of: a 4-pentenylboronic acid, a trans-propenylboronic acid, a cis-propenylboronic acid, a 3,3-dimethyl-1-butenylboronic acid, a cyclopenten-1-ylboronic acid, a 2,2-dimethylethenylboronic acid and any combination thereof.

In alternative embodiments, the boronic acid or boronic acid derivative comprises an arylboronic acid selected from the group consisting of: a phenylboronic acid, a 2-phenyl-1-ethylboronic acid, a 2,6-dimethoxy-4-methylphenylboronic acid, a 3-tert-butylphenylboronic acid, a p-tolylboronic acid, a 3,5-dimethylphenylboronic acid, a 3-isopropylphenylboronic acid, a 1,4-benzenediboronic acid, a p-tolylboronic acid, a 3-methoxyphenylboronic acid, a 4-methoxyphenylboronic acid, 3-tert-butylphenylboronic acid, a 2-methoxyphenylboronic acid, a 3,4-dimethoxyphenylboronic acid, a 3-fluorophenylboronic acid, a 2-(trifluoromethyl)phenylboronic acid, a 4-(trifluoromethyl)phenylboronic acid, a 3,5-difluorophenylboronic acid, a 2-fluorophenylboronic acid, a 3,4-difluorophenylboronic acid and any combination thereof.

In alternative embodiments, provided are thermal energy storage compositions comprising a boronic acid or boronic acid derivatives phase change material (PCM), wherein the PCM undergoes solid to liquid and liquid to solid phase change transitions.

In alternative embodiments, the boronic acid or boronic acid derivative comprises a non-aromatic cyclic boronic acid selected from the group consisting of: a cyclohexylboronic acid, a neopentylboronic acid, a cyclopentylboronic acid, cyclobutylboronic acid, cyclopropylboronic acid, a cyclohexylboronic acid and any combination thereof.

In alternative embodiments, the boronic acid or boronic acid derivative comprises an alkyl boronic acid selected from the group consisting of: a methylboronic acid, a (methoxymethyl)boronic acid, an ethylboronic acid, an isopropylboronic acid, a 1-propylboronic acid, a (2-methylpropyl)boronic acid, a n-butylboronic acid, a sec-butylboronic acid, a tert-butylboronic acid, a 4-bromobutylboronic acid, a 1-pentylboronic acid, an isopentylboronic acid, a neopentylboronic acid, an n-hexylboronic acid, a 1,6-hexanediboronic acid, a n-heptylboronic acid, a 1-octylboronic acid, a n-nonylboronic acid, a 1-decylboronic acid, a n-dodecaneboronic acid, a n-hexadecaneboronic acid, an n-octadecaneboronic acid, a n-eicosaneboronic acid, a n-tricontaneboronic acid, a benzylboronic acid and any combination thereof.

In alternative embodiments, the boronic acid or boronic acid derivative comprises an alkene boronic acid selected from the group consisting of: a 4-pentenylboronic acid, a trans-propenylboronic acid, a cis-propenylboronic acid, a 3,3-dimethyl-1-butenylboronic acid, a cyclopenten-1-ylboronic acid, a 2,2-dimethylethenylboronic acid and any combination thereof.

In alternative embodiments, the boronic acid or boronic acid derivative comprises an arylboronic acid selected from the group consisting of: a phenylboronic acid, a 2-phenyl-1-ethylboronic acid, a 2,6-dimethoxy-4-methylphenylboronic acid, a 3-tert-butylphenylboronic acid, a p-tolylboronic acid, a 3,5-dimethylphenylboronic acid, a 3-isopropylphenylboronic acid, a 1,4-benzenediboronic acid, a p-tolylboronic acid, a 3-methoxyphenylboronic acid, a 4-methoxyphenylboronic acid, 3-tert-butylphenylboronic acid, a 2-methoxyphenylboronic acid, a 3,4-dimethoxyphenylboronic acid, a 3-fluorophenylboronic acid, a 2-(trifluoromethyl)phenylboronic acid, a 4-(trifluoromethyl)phenylboronic acid, a 3,5-difluorophenylboronic acid, a 2-fluorophenylboronic acid, a 3,4-difluorophenylboronic acid and any combination thereof.

In alternative embodiments, provided are building materials, building superstructures, or products of manufacture, or compositions or articles, comprising a mixture of: (a) (i) a phase change material (PCM) composition comprising a boronic acid or boronic acid derivative, wherein the PCM undergoes solid to liquid and liquid to solid phase change transitions, wherein optionally the boronic acid is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (ii) a thermal energy storage composition, product of manufacture or system as provided herein, (iii) a thermal energy storage composition as provided herein; or (iv) any combination thereof and (b) an insulation material, a conventional insulation material or a composition.

In alternative embodiments, the building materials, products of manufacture, or compositions or articles comprise: a wall, a ceiling, a flooring, a window or window covering, a liquid (e.g., a liquid nitrogen or liquid oxygen), a gasoline, a diesel, a gas (e.g., a fluorinated aliphatic organic compound gas such as FREON™, a helium, a nitrogen), an oil, or a fuel, or a transport or a storage device or container, or a tank device; or a weapons system or a missile.

In alternative embodiments, provided are food or textile storage materials, body armor, helmets, devices, refrigerators, coolers, shipping containers, or containers; or textiles, comprising: (a) a phase change material (PCM) composition comprising a boronic acid or boronic acid derivative, wherein the PCM undergoes solid to liquid and liquid to solid phase change transitions, wherein optionally the boronic acid or boronic acid derivative is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage composition, product of manufacture or system as provided herein, (c) a thermal energy storage composition as provided herein; or (d) any combination thereof.

In alternative embodiments, provided are an automotive, a truck, a train, an airplane, or a ship body; or, a superstructure, material, part or frame of an automotive, a truck, a train, an airplane, or a ship body, comprising: (a) a phase change material (PCM) composition comprising a boronic acid or boronic acid derivative, wherein the PCM undergoes solid to liquid and liquid to solid phase change transitions, wherein optionally the boronic acid or boronic acid derivative is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage composition, product of manufacture or system as provided herein, (c) a thermal energy storage composition as provided herein; or (d) any combination thereof.

In alternative embodiments, provided are medical devices comprising: (a) a phase change material (PCM) composition comprising a boronic acid or boronic acid derivative, wherein the PCM undergoes solid to liquid and liquid to solid phase change transitions, wherein optionally the boronic acid or boronic acid derivative is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM, (b) a thermal energy storage composition, product of manufacture or system as provided herein, (c) a thermal energy storage composition as provided herein; or (d) any combination thereof.

In alternative embodiments, provided are processes or methods for storage of heat comprising heat transfer to and from a heat storage medium or phase change material (PCM) whereby the heat storage medium changes phase as it absorbs or releases heat, the heat storage medium or phase change material (PCM) comprising a boronic acid, a boronic acid derivative or a combination thereof. In alternative embodiments of the processes, the heat storage medium or phase change material (PCM) comprises at least about one percent, 2%, 3%, 4%, 5%, 10%, 15%, 20%, 25%, 30%, 35%, 40%, 45%, or 50% or more by weight, or between about 1% and 50% by weight, or between about 5% and 75% by weight, of the boronic acid or boronic acid derivative.

In alternative embodiments of the processes, the heat storage medium or phase change material (PCM) comprises a non-aromatic cyclic boronic acid selected from the group consisting of: a cyclohexylboronic acid, a neopentylboronic acid, a cyclopentylboronic acid, cyclobutylboronic acid, cyclopropylboronic acid, a cyclohexylboronic acid and any combination thereof. In alternative embodiments of the processes, the heat storage medium or phase change material (PCM) comprises an alkyl boronic acid selected from the group consisting of: a methylboronic acid, a (methoxymethyl)boronic acid, an ethylboronic acid, an isopropylboronic acid, a 1-propylboronic acid, a (2-methylpropyl)boronic acid, a n-butylboronic acid, a sec-butylboronic acid, a tert-butylboronic acid, a 4-bromobutylboronic acid, a 1-pentylboronic acid, a isopentylboronic acid, a neopentylboronic acid, a n-hexylboronic acid, a 1,6-hexanediboronic acid, a n-heptylboronic acid, an 1-octylboronic acid, a n-nonylboronic acid, a 1-decylboronic acid, a n-dodecaneboronic acid, a n-hexadecaneboronic acid, an n-octadecaneboronic acid, a n-eicosaneboronic acid, a n-tricontaneboronic acid, a benzylboronic acid and any combination thereof. In alternative embodiments of the processes, the heat storage medium or phase change material (PCM) comprises an alkene boronic acid selected from the group consisting of: a 4-pentenylboronic acid, a trans-propenylboronic acid, a cis-propenylboronic acid, a 3,3-dimethyl-1-butenylboronic acid, a cyclopenten-1-ylboronic acid, a 2,2-dimethylethenylboronic acid and any combination thereof.

In alternative embodiments of the processes, the heat storage medium or phase change material (PCM) comprises an arylboronic acid selected from the group consisting of: a phenylboronic acid, a 2-phenyl-1-ethylboronic acid, a 2,6-dimethoxy-4-methylphenylboronic acid, a 3-tert-butylphenylboronic acid, a p-tolylboronic acid, a 3,5-dimethylphenylboronic acid, a 3-isopropylphenylboronic acid, a 1,4-benzenediboronic acid, a p-tolylboronic acid, a 3-methoxyphenylboronic acid, a 4-methoxyphenylboronic acid, a 3-tert-butylphenylboronic acid, a 2-methoxyphenylboronic acid, a 3,4-dimethoxyphenylboronic acid, a 3-fluorophenylboronic acid, a 2-(trifluoromethyl)phenylboronic acid, a 4-(trifluoromethyl)phenylboronic acid, a 3,5-difluorophenylboronic acid, a 2-fluorophenylboronic acid, a 3,4-difluorophenylboronic acid and any combination thereof.

In alternative embodiments of the processes, the heat storage medium or phase change material (PCM) comprises a PCM formed as one of: a structural part or material, an insulation material, a building material, a storage device, a food storage device, a shipping container, a cooling or a heating device, a permanent or a temporary dwelling or shelter, a roof, a wall, a floor, a housing siding, an aircraft, an automobile or a motorized vehicle, a boat, a motor, a textile material or an apparel, a medical device, an industrial device, or a component adjacent to electrical equipment.

In alternative embodiments of the processes, a phase change occurs within the heat storage medium or phase change material (PCM) between about 50° C. to 350° C., between about 25° C. to 450° C., or about 25° C., 50° C., 75° C., 100° C., 125° C., 150° C., 175° C., 100° C., 250° C., 300° C. or 350° C. or more.

The details of one or more embodiments as provided and described herein are set forth in the accompanying drawings and the description below. Other features, objects, and advantages of the invention will be apparent from the description and drawings, and from the claims.

All publications, patents, patent applications cited herein are hereby expressly incorporated by reference for all purposes.

### DETAILED DESCRIPTION OF THE DRAWINGS

For a more accurate understanding of exemplary embodiments, reference is now made to the following description in conjunction with the accompanying drawing, in which:

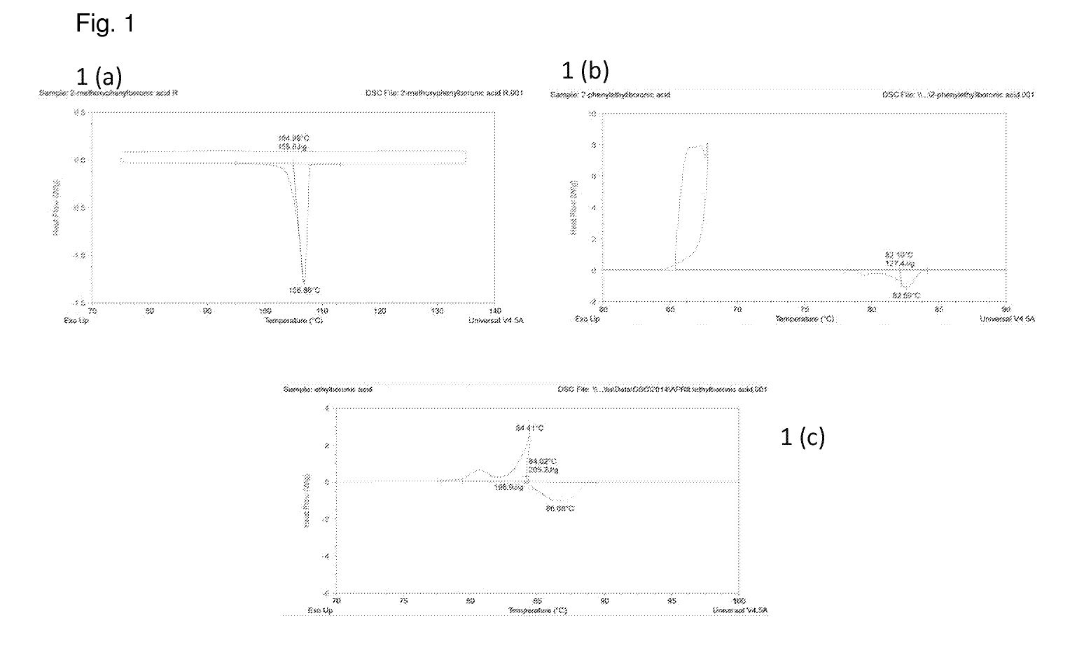

FIG. 1(a)-1(c) illustrate Differential Scanning calorimetry (DSC) scans (or DSC thermograms) of exemplary boronic acids 2-methoxyphenylboronic acid, 2-phenylethylboronic acid, and ethylboronic acid respectively, which may be used as Phase Change Material (PCMs) in alternative embodiments provided herein.

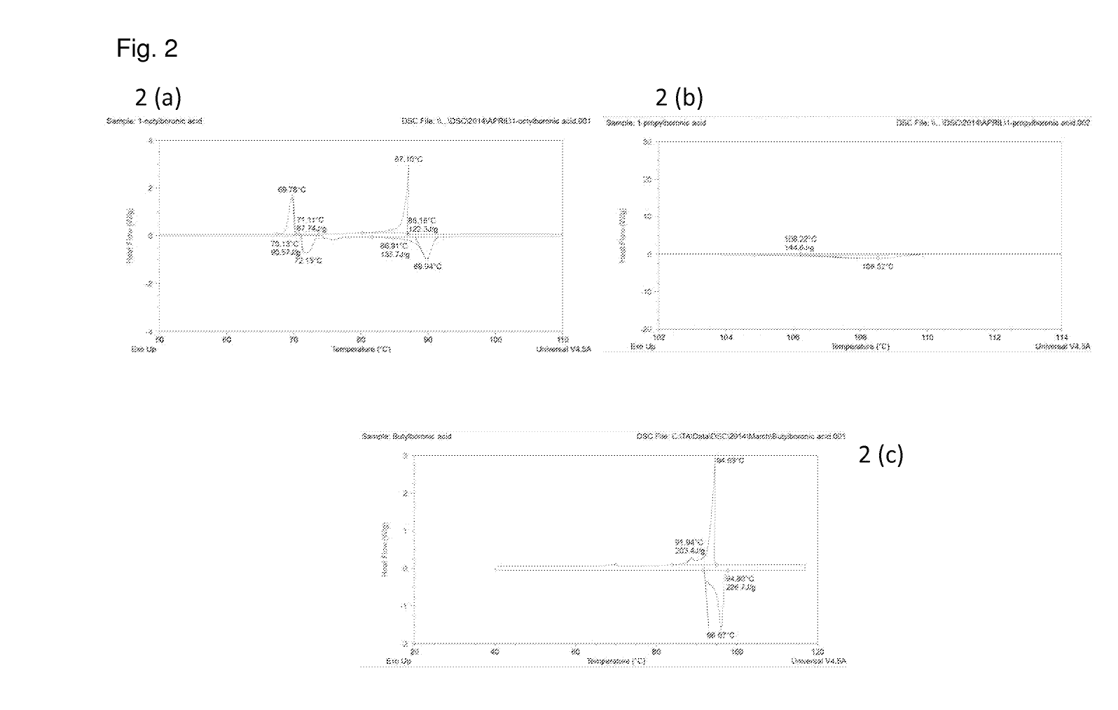

FIG. 2(a)-2(c) illustrate Differential Scanning calorimetry (DSC) scans (or DSC thermograms) of exemplary boronic acids 1-octylboronic acid, 1-propylboronic acid, and butylboronic acid which may be used as PCMs in alternative embodiments provided herein.

Reference will now be made in detail to various exemplary embodiments as provided and described herein. The following detailed description is provided to give the reader a better understanding of certain details of aspects and exemplary embodiments, and should not be interpreted as a limitation on the scope of the invention.

### DETAILED DESCRIPTION

In alternative embodiments, provided are compounds for use as Phase Change Material (PCMs) in thermal energy storage materials and/or thermal energy storage systems. In alternative embodiments, provided are PCMs comprising boronic acid compounds for use in thermal energy management. In alternative embodiments, boronic acids having desirable PCM characteristics are used, including boronic acids having high latent heats which is comparable or higher than most commercially available PCMs. Because of the diversity and commercial availability of reagents suitable for the production boronic acids, provided are a range of boronic acid PCMs, each with a unique melting point that can be tailored for a specific thermal energy management application. In alternative embodiments, boronic acids that are more environmentally friendly than commercially available PCMs are used; boronic acids themselves as well as their decomposition products (primarily alcohols and boric acids) are generally non-toxic.

In alternative embodiments, boronic acids having favorable PCM characteristics, including high latent heats, are used, for example, high latent heats between about 90 to 300 J/g, and a range of melting points, e.g. between about 20 to 250° C. Table 1 shows the melting points and latent heat of exemplary boronic acids that may be used in alternative embodiments, as measured using Differential Scanning calorimetry (DSC).

TABLE 1
Melting points and latent heat of exemplary boronic acids

| Boronic Acid | Melting point (° C.) | Latent Heat (J/g) |
|---|---|---|
| 2-methoxyphenylboronic acid | 107 | 155.8 |
| 2-phenlethylboronic acid | 83 | 127.4 |
| ethylboronic acid | 87 | 205.2 |
| 1-octylboronic acid | 90 | 122.3 |
| 1-propylboronic acid | 109 | 144.6 |
| butylboronic acid | 96 | 226.7 |

In alternative embodiments, the boronic acid PCM comprises a non-aromatic cyclic boronic acid, e.g. cyclohexylboronic acid, neopentylboronic acid, cyclopentylboronic acid, cyclobutylboronic acid, cyclopropylboronic acid, or cyclohexylboronic acid or any combination thereof.

In alternative embodiments, the boronic acid PCM comprises an alkyl boronic acid, e.g. methylboronic acid, (methoxymethyl)boronic acid, ethylboronic acid, isopropylboronic acid, 1-propylboronic acid, (2-methylpropyl)boronic acid, n-butylboronic acid, sec-butylboronic acid, tert-butylboronic acid 4-bromobutylboronic acid, 1-pentylboronic acid, isopentylboronic acid, neopentylboronic acid, n-hexylboronic acid, 1,6-hexanediboronic acid, n-heptylboronic acid, 1-octylboronic acid, n-nonylboronic acid, 1-decylboronic acid, a n-dodecaneboronic acid, a n-hexadecaneboronic acid, an n-octadecaneboronic acid, a n-eicosaneboronic acid, a n-tricontaneboronic acid, a benzylboronic acid or any combination thereof.

In alternative embodiments, the boronic acid PCM comprises an alkene boronic acid, e.g. 4-pentenylboronic acid, trans-propenylboronic acid, cis-propenylboronic acid, 3,3-dimethyl-1-butenylboronic acid, and cyclopenten-1-ylboronic acid, or 2,2-dimethylethenylboronic acid.

In alternative embodiments, the boronic acid PCM comprises an arylboronic acid, e.g. phenylboronic acid, 2-phenyl-1-ethylboronic acid, 2,6-dimethoxy-4-methylphenylboronic acid, 3-tert-butylphenylboronic acid, p-tolylboronic acid, 3,5-dimethylphenylboronic acid, 3-isopropylphenylboronic acid, 1,4-benzenediboronic acid, p-tolylboronic acid, 3-methoxyphenylboronic acid, 4-methoxyphenylboronic acid, 3-tert-butylphenylboronic acid, 2-methoxyphenylboronic acid, 3,4-dimethoxyphenylboronic acid, 3-fluorophenylboronic acid, 2-(trifluoromethyl)phenylboronic acid, 4-(trifluoromethyl)phenylboronic acid, 3,5-difluorophenylboronic acid, 2-fluorophenylboronic acid, or 3,4-difluorophenylboronic acid or any combination thereof.

In alternative embodiments, the boronic acid PCM is synthesized using commercially available halides and a borate. In an exemplary embodiment, a halide is reacted with a borate and magnesium, e.g. turnings or powder magnesium, in the presence of a solvent, e.g. and ether solvent. Hydrochloric acid is added to the reaction mixture in an amount that is sufficient to stop the reaction, thereby preventing the formation of degradation products. Suitable solvents include, for example, diethyl ether or tetrahydrofuran. In the forgoing reaction, an intermediate Grignard reagent is generated from a reaction between the halide and the magnesium. The Grignard intermediate then reacts with the borate to generate a boronic acid. Suitable borates include, without limitation, trimethyl borate, triethyl borate, tri-n-butyl borate, or triisopropyl borate. The foregoing reaction is illustrated in Reaction Scheme 1.

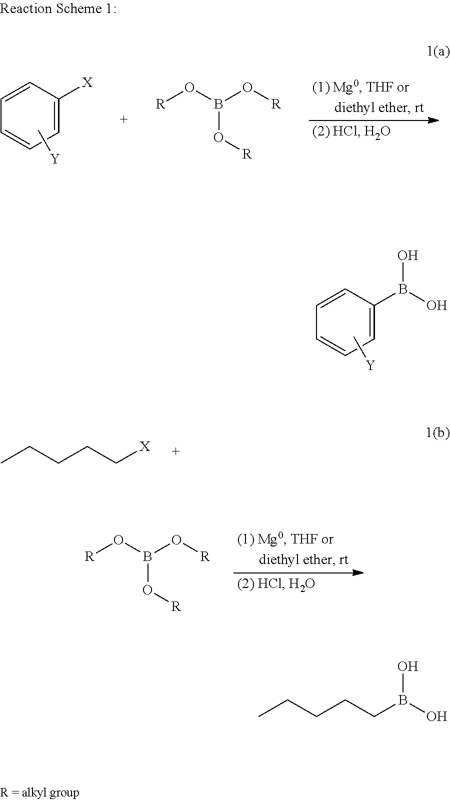

In alternative embodiments the halide is an aryl halide (as shown in Reaction Scheme 1(a)). In such embodiments, the resulting boronic acid product is an aryl boronic acid. In alternative embodiments, the aryl halide comprises a benzene ring and a halogen substituent attached at position (i.e. at any of the 1^{st}, 2^{nd}, 3^{rd}, 4^{th}, 5^{th}, or 6^{th}, carbon position) in the benzene ring. Examples of suitable halogen substituents include bromide, iodide, and chloride. In alternative embodiments, the aryl halide is unsubstituted. Examples of commercially available aryl halides suitable for use in the production of boronic acids used in exemplary embodiments and as provided herein include, without limitation: 2-bromotoluene, 3-bromotoluene, 4-bromotoluene, 1-bromo-2-fluorobenzene, 4-bromoanisole, 3-bromoanisole, 2-bromoanisole, 1-bromo-2,4-dimethylbenzene 3-dimethoxy-2-bromobenzene, 2,3,4-(trimethoxy)bromobenzene, 1,3-bis(trifluoromethyl)-5-bromobenzene, 2-methyl-4-(trifluoromethoxy)bromobenzene, and 4-bromodiphenyl ether.

In alternative embodiments, the halide comprises an alkyl halide (as shown in Reaction Scheme 1(b)). In such embodiments, the resulting boronic acid product is an alkyl boronic acid. The alkyl halide can be a straight chain, branched alkyl halide, or a cyclic alkyl halide. The halogen group of the alkyl halide can be, for example, bromide, iodide, or chloride. Examples of commercially available alkyl halides suitable for use in the production of boronic acid used in exemplary embodiments include, without limitation: 1-bromobutane, 1-bromopropane, 1-bromohexane, 1-bromoheptane, 1-bromooctane, 1-bromononane, 1-bromodecane, 1-bromoundecane, 1-bromododecane, 1-bromopentadecane, 1-bromohexadecane, 1-bromoheptadecane, 1-bromooctadecane, 1-bromononadecane, benzylbromide, 1-bromoeicosane, 1-bromotriacotane, 2-bromobutane, neopentyl bromide, isobutyl bromide, isopentyl bromide, 1-bromo-2,2-dimethylpropane, 1-bromo-4-methylpentane, 1-bromo-3,7-dimethyloctane, 2-bromododecane, bromocyclopropane, bromocyclobutane, bromocyclopentane, bromocyclohexane, and bromocyclooctane. In some instances, the desired compounds may contain two boronic acid groups. In these instances, dialkyl bromides will be utilized. These commercially available dialkyl halides include 1,2-dibromopropane, 1,3-dibromopropane, 1,5-dibromopentane, 1,4-dibromobutane, 1,3-dibromobutane, 1,2-dibromobutane, 2,3-dibromobutane, 1,4-dibromopentane, 1,5-dibromo-3-methylpentane, 1,10-dibromodecane, 4-(trifluoromethyl)phenethyl bromide, 1,11-dibromoundecane, 1,12-dibromododecane, 1,18-dibromooctadecane, and 1,20-dibromoeicosane.

In alternative embodiments, the boronic acid PCM is synthesized using commercially available Grignard reagents, wherein said Grignard reagents are reacted with a borate in the presence of an ether solvent. Suitable solvents include, for example, diethyl ether or tetrahydrofuran. In alternative embodiments, hydrochloric acid is added to the reaction mixture at a time and in an amount such that the formation of the boronic acid product is maximized, and the reaction is stopped prior to the formation of degradation products. In such embodiments, Grignard reagents react with a borate to form a boronic acid. Suitable borates include, without limitation, trimethyl borate, triethyl borate, tri-n-butyl borate, or triisopropyl borate. The foregoing reaction is illustrated in Reaction Scheme 3.

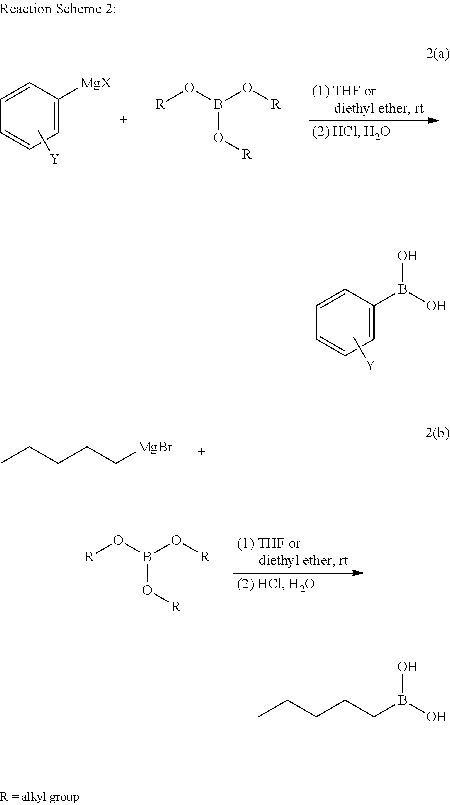

In alternative embodiments the Grignard reagent comprises an aryl group (as shown in Reaction Scheme 2(a)). In such embodiments, the resulting boronic acid product is an aryl boronic acid. Examples of suitable halogen substituents include bromide, iodide, and chloride. Examples of commercially available Grignard reagents comprising an aryl group suitable for use in the production of boronic acid used in exemplary embodiments include, without limitation: phenylmagnesium chloride, 2-methoxyphenylmagnesium bromide, pentafluorophenylmagnesium bromide, 2-methylphenylmagnesium bromide, 3-methylphenylmagnesium bromide, 4-methylphenylmagnesium bromide, 4-chlorophenylmagnesium bromide, [4-(4-morpholinylmethyl)phenyl]magnesium bromide, 4-(trifluoromethoxy)benzylmagnesium bromide, 2-mesitylmagnesium bromide, and 4-fluorophenylmagnesium bromide.

In alternative embodiments, the Grignard reagent comprise an alkyl group (as shown in Reaction Scheme 2(b)). In such embodiments, the resulting boronic acid product is an alkyl boronic acid. The alkyl group can be a straight chain or a branched alkyl halide. Examples of commercially available Grignard reagents comprising an alkyl group suitable for use in the production of boronic acid used in exemplary embodiments include, without limitation: methylmagnesium bromide, ethylmagnesium bromide, butylmagnesium bromide, decylmagnesium bromide, isobutylmagnesium bromide, isopropylmagnesium bromide, pentamethylenebis(magnesium bromide), hexylmagnesium bromide, octylmagnesium bromide, pentadecylmagnesium bromide, (trimethylsilyl)methylmagnesium bromide, and octadecylmagnesium bromide.

In alternative embodiments, the boronic acid PCM is synthesized using commercially available organolithium reagents, wherein said organolithium reagents are reacted with a borate in the presence of an ether solvent. Suitable solvents include, for example, diethyl ether or tetrahydrofuran. In alternative embodiments, hydrochloric acid is added to the reaction mixture at a time and in an amount such that the formation of the boronic acid product is maximized, and the reaction is stopped prior to the formation of degradation products. In such embodiments, the organolithium reagent reacts with a borate to form a boronic acid. Suitable borates include, without limitation, trimethyl borate, triethyl borate, tri-n-butyl borate, or triisopropyl borate. The foregoing reaction is illustrated in Reaction Scheme 3.

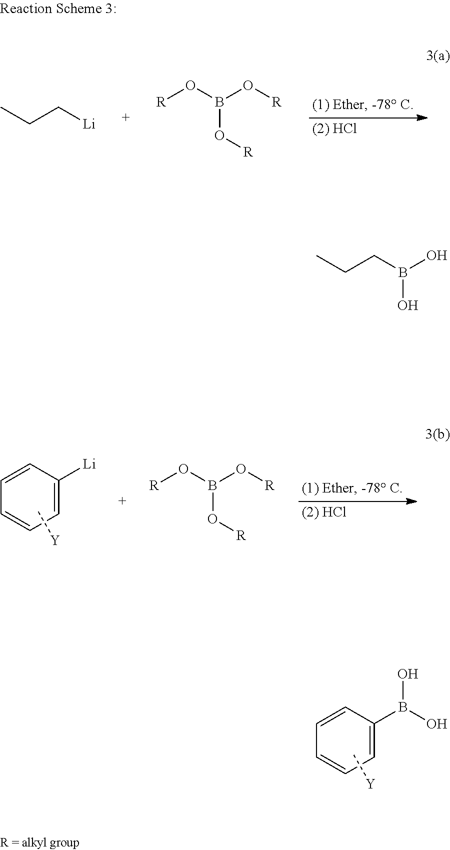

In alternative embodiments, the organolithium reagent is an alkyl lithium reagent (as shown in Reaction Scheme 3(a)). In such embodiments, the resulting boronic acid product is an alkyl boronic acid. The alkyl group can be a straight chain or a branched organolithium reagent. Examples of commercially available alkyl lithium reagents suitable for use in the production of boronic acid used in exemplary embodiments include, without limitation: methyllithium, ethyllithium, n-butyllithium, sec-butyllithium, isobutyllithium, and isopropyllithium.

In alternative embodiments the lithium reagent is an aryl lithium reagent (as shown in Reaction Scheme 3(b)). In such embodiments, the resulting boronic acid product is an aryl boronic acid. Examples of commercially available aryl lithium reagents suitable for use in the production of boronic acid used in exemplary embodiments include, without limitation: phenyllithium, and 4-(trimethylsilyl)phenyllithium.

In alternative embodiments, the thermal energy storage materials as provided herein can comprise an encapsulated boronic acid PCM. The boronic acid PCMs as provided herein can be encapsulated by any of several known methods generally known in the art. The encapsulated PCMs can be microencapsulated, i.e. generally contained capsules of less than 1 mm in diameter, or they can be macroencapsulated, i.e. generally contained in capsules of greater than 1 mm in diameter.

In alternative embodiments, the thermal energy storage materials as provided herein comprise a heterogeneous mixture of the boronic acid PCM material, and one or more additional materials, e.g. a building material comprising a mixture of boronic acid PCM and a conventional insulating material such as fiberglass. In other embodiments, the boronic acid PCM thermal storage materials can be homogeneous, meaning that they are not incorporated into a mixture of materials, e.g. as a thermal energy layer comprised of boronic acid within a package used to transport food or the like. In certain embodiments, the boronic acid PCM thermal storage materials can be incorporated into existing thermal energy management systems, e.g. building insulation, coolers, industrial thermals storage tanks, residential heating systems, or the like.

FIGS. 1(a), 1(b), and 1(c) show the DSC thermograms for the exemplary boronic acid derivatives 2-methoxyphenylboronic acid, 2-phenylethylboronic acid, and ethylboronic acid respectively. Table 1 summarize the thermal characteristics obtained from the thermograms for the selected boronic acids. All show favorable latent heat storage capabilities of greater than (>) 120 J/g.

FIGS. 2(a), 2(b) and 2(c) show the DSC thermograms for exemplary boronic acid derivatives 1-octylboronic acid, 1-propylboronic acid, and butylboronic acid. Table 1 summarize the thermal characteristics obtained from the thermograms for the selected boronic acids. All show favorable latent heat storage capabilities of greater than 120 J/g.

Although exemplary embodiments have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, compositions of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A thermal energy storage composition, product of manufacture or system comprising:
a phase change material (PCM) composition comprising a boronic acid or boronic acid derivative, wherein the PCM undergoes solid to liquid and liquid to solid phase change transitions,
wherein optionally the boronic acid or boronic acid derivative is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%^{,} 88%, 89%, 90%, 91%, 92%, 93%, 94%, 95%, 96%, 97%, 98%, 99%, or more of the volume of the PCM.

2. The thermal energy storage composition, product of manufacture or system of claim 1, wherein the boronic acid or boronic acid derivative comprises a non-aromatic cyclic boronic acid selected from the group consisting of: a cyclohexylboronic acid, a neopentylboronic acid, a cyclopentylboronic acid, cyclobutylboronic acid, cyclopropylboronic acid, a cyclohexylboronic acid and any combination thereof.

3. The thermal energy storage composition, product of manufacture or system of claim 1, wherein the boronic acid or boronic acid derivative comprises an alkyl boronic acid selected from the group consisting of: a methylboronic acid, a (methoxymethyl)boronic acid, an ethylboronic acid, an isopropylboronic acid, a 1-propylboronic acid, a (2-methylpropyl)boronic acid, a n-butylboronic acid, a sec-butylboronic acid, a tert-butylboronic acid, a 4-bromobutylboronic acid, a 1-pentylboronic acid, a isopentylboronic acid, a neopentylboronic acid, a n-hexylboronic acid, a 1,6-hexanediboronic acid, a n-heptylboronic acid, an 1-octylboronic acid, a n-nonylboronic acid, a 1-decylboronic acid, a n-dodecaneboronic acid, a n-hexadecaneboronic acid, an n-octadecaneboronic acid, a n-eicosaneboronic acid, a n-tricontaneboronic acid, a benzylboronic acid and any combination thereof.

4. The thermal energy storage composition, product of manufacture or system of claim 1, wherein the boronic acid or boronic acid derivative comprises an alkene boronic acid selected from the group consisting of: a 4-pentenylboronic acid, a trans-propenylboronic acid, a cis-propenylboronic acid, a 3,3-dimethyl-1-butenylboronic acid, a cyclopenten-1-ylboronic acid, a 2,2-dimethylethenylboronic acid and any combination thereof.

5. The thermal energy storage composition, product of manufacture or system of claim 1, wherein the boronic acid or boronic acid derivative comprises an arylboronic acid selected from the group consisting of: a phenylboronic acid, a 2-phenyl-1-ethylboronic acid, a 2,6-dimethoxy-4-methylphenylboronic acid, a 3-tert-butylphenylboronic acid, a p-tolylboronic acid, a 3,5-dimethylphenylboronic acid, a 3-isopropylphenylboronic acid, a 1,4-benzenediboronic acid, a p-tolylboronic acid, a 3-methoxyphenylboronic acid, a 4-methoxyphenylboronic acid, 3-tert-butylphenylboronic acid, a 2-methoxyphenylboronic acid, a 3,4-dimethoxyphenylboronic acid, a 3-fluorophenylboronic acid, a 2-(trifluoromethyl)phenylboronic acid, a 4-(trifluoromethyl)phenylboronic acid, a 3,5-difluorophenylboronic acid, a 2-fluorophenylboronic acid, a 3,4-difluorophenylboronic acid and any combination thereof.

6. A thermal energy storage composition comprising a boronic acid or boronic acid derivative phase change material (PCM), wherein the PCM undergoes solid to liquid and liquid to solid phase change transitions.

7. The thermal energy storage composition of claim 6, wherein the boronic acid or boronic acid derivative comprises a non-aromatic cyclic boronic acid selected from the group consisting of: a cyclohexylboronic acid, a neopentylboronic acid, a cyclopentylboronic acid, cyclobutylboronic acid, cyclopropylboronic acid, a cyclohexylboronic acid and any combination thereof.

8. The thermal energy storage composition of claim 6, wherein the boronic acid or boronic acid derivative comprises an alkyl boronic acid selected from the group consisting of: a methylboronic acid, a (methoxymethyl)boronic acid, an ethylboronic acid, an isopropylboronic acid, a 1-propylboronic acid, a (2-methylpropyl)boronic acid, a n-butylboronic acid, a sec-butylboronic acid, a tert-butylboronic acid 4-bromobutylboronic acid, a 1-pentylboronic acid, a isopentylboronic acid, a neopentylboronic acid, a n-hexylboronic acid, a 1,6-hexanediboronic acid, a n-heptylboronic acid, an 1-octylboronic acid, a n-nonylboronic acid, a 1-decylboronic acid, a n-dodecaneboronic acid, a n-nonylboronic acid, a 1-decylboronic acid, a n-dodecaneboronic acid, a n-hexadecaneboronic acid, an n-octadecaneboronic acid, a n-eicosaneboronic acid, a n-tricontaneboronic acid, a benzylboronic acid and any combination thereof.

9. The thermal energy storage composition of claim 6, wherein the boronic acid or boronic acid derivative comprises an alkene boronic acid selected from the group consisting of: a 4-pentenylboronic acid, a trans-propenylboronic acid, a cis-propenylboronic acid, a 3,3-dimethyl-1-butenylboronic acid, a cyclopenten-1-ylboronic acid, a 2,2-dimethylethenylboronic acid and any combination thereof.

10. The thermal energy storage composition of claim 6, wherein the boronic acid or boronic acid derivative comprises an arylboronic acid selected from the group consisting of: a phenylboronic acid, a 2-phenyl-1-ethylboronic acid, a 2,6-dimethoxy-4-methylphenylboronic acid, a 3-tert-butylphenylboronic acid, a p-tolylboronic acid, a 3,5-dimethylphenylboronic acid, a 3-isopropylphenylboronic acid, a 1,4-benzenediboronic acid, a p-tolylboronic acid, a 3-methoxyphenylboronic acid, a 4-methoxyphenylboronic acid, a 3-tert-butylphenylboronic acid, a 2-methoxyphenylboronic acid, a 3,4-dimethoxyphenylboronic acid, a 3-fluorophenylboronic acid, a 2-(trifluoromethyl)phenylboronic acid, a 4-(trifluoromethyl)phenylboronic acid, a 3,5-difluorophenylboronic acid, a 2-fluorophenylboronic acid, a 3,4-difluorophenylboronic acid and any combination thereof.

11. A building material, a building superstructure, or a product of manufacture comprising a mixture of:
(a)
(i) a phase change material (PCM) composition comprising a boronic acid or boronic acid derivative, wherein the PCM undergoes solid to liquid and liquid to solid phase change transitions, wherein optionally the boronic acid or boronic acid derivative is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM,
(ii) a thermal energy storage composition, product of manufacture or system of claim 1,
or
(iii) any combination thereof; and
(b) an insulation material, a conventional insulation material or a composition.

12. The building material or building superstructure, or product of manufacture of claim 11, wherein the building material comprises a wall, a ceiling, a flooring, a window or window covering, or a tank device.

13. A food or textile storage material, device, refrigerator, cooler, shipping container, or a container; or a textile, comprising:
(a) a phase change material (PCM) composition comprising a boronic acid or boronic acid derivative, wherein the PCM undergoes solid to liquid and liquid to solid phase change transitions, wherein optionally the boronic acid is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM,
(b) a thermal energy storage composition, product of manufacture or system of claim 1, or
(c) any combination thereof.

14. An automotive, a truck, a train, an airplane, or a ship body, superstructure, material, part or frame comprising:
(a) a phase change material (PCM) composition comprising a boronic acid or boronic acid derivative, wherein the PCM undergoes solid to liquid and liquid to solid phase change transitions, wherein optionally the boronic acid or boronic acid derivative is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM,
(b) a thermal energy storage composition, product of manufacture or system of claim 1, or
(c) any combination thereof.

15. A medical device comprising:
(a) a phase change material (PCM) composition comprising a boronic acid or boronic acid derivative, wherein the PCM undergoes solid to liquid and liquid to solid phase change transitions, wherein optionally the boronic acid or boronic acid derivative is at least about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, or more of the volume of the PCM,
(b) a thermal energy storage composition, product of manufacture or system of claim 1, or
(c) any combination thereof.

16. A process or a method for storage of heat comprising heat transfer to and from a heat storage medium or a phase change material (PCM) whereby the heat storage medium changes phase as it absorbs or releases heat, the heat storage medium or phase change material (PCM) comprising a boronic acid, a boronic acid derivative or a combination thereof.

17. The process of claim 16 wherein the heat storage medium or phase change material (PCM) comprises at least about one percent, 2%, 3%, 4%, 5%, 10%, 15%, 20%, 25%, 30%, 35%, 40%, 45%, or 50% or more by weight, or between about 1% and 50% by weight, or between about 5% and 75% by weight, of the boronic acid or boronic acid derivative.

18. The process of claim 16 wherein the heat storage medium or phase change material (PCM) comprises a non-aromatic cyclic boronic acid or boronic acid derivative selected from the group consisting of: a cyclohexylboronic acid, a neopentylboronic acid, a cyclopentylboronic acid, cyclobutylboronic acid, cyclopropylboronic acid, a cyclohexylboronic acid and any combination thereof.

19. The process of claim 16 wherein the heat storage medium or phase change material (PCM) comprises an alkyl boronic acid selected from the group consisting of: a methylboronic acid, a (methoxymethyl)boronic acid, an ethylboronic acid, an isopropylboronic acid, a 1-propylboronic acid, a (2-methylpropyl)boronic acid, a n-butylboronic acid, a sec-butylboronic acid, a tert-butylboronic acid, a 4-bromobutylboronic acid, a 1-pentylboronic acid, a isopentylboronic acid, a neopentylboronic acid, a n-hexylboronic acid, a 1,6-hexanediboronic acid, a n-heptylboronic acid, an 1-octylboronic acid, a n-nonylboronic acid, a 1-decylboronic acid, a n-dodecaneboronic acid, a n-hexadecaneboronic acid, an n-octadecaneboronic acid, a n-eicosaneboronic acid, a n-tricontaneboronic acid, a benzylboronic acid and any combination thereof.

20. The process of claim 16 wherein:
(a) the heat storage medium or phase change material (PCM) comprises an alkene boronic acid selected from the group consisting of: a 4-pentenylboronic acid, a trans-propenylboronic acid, a cis-propenylboronic acid, a 3,3-dimethyl-1-butenylboronic acid, a cyclopenten-1-ylboronic acid, a 2,2-dimethylethenylboronic acid and any combination thereof;
(b) the heat storage medium or phase change material (PCM) comprises an arylboronic acid selected from the group consisting of: a phenylboronic acid, a 2-phenyl-1-ethylboronic acid, a 2,6-dimethoxy-4-methylphenylboronic acid, a 3-tert-butylphenylboronic acid, a p-tolylboronic acid, a 3,5-dimethylphenylboronic acid, a 3-isopropylphenylboronic acid, a 1,4-benzenediboronic acid, a p-tolylboronic acid, a 3-methoxyphenylboronic acid, a 4-methoxyphenylboronic acid, a 3-tert-butylphenylboronic acid, a 2-methoxyphenylboronic acid, a 3,4-dimethoxyphenylboronic acid, a 3-fluorophenylboronic acid, a 2-(trifluoromethyl)phenylboronic acid, a 4-(trifluoromethyl)phenylboronic acid, a 3,5-difluorophenylboronic acid, a 2-fluorophenylboronic acid, a 3,4-difluorophenylboronic acid and any combination thereof,
(c) the heat storage medium or phase change material (PCM) comprises a PCM formed as one of: a structural part or material, an insulation material, a storage device, a food storage device, a shipping container, a cooling or a heating device, a permanent or a temporary dwelling or shelter, a roof, a wall, a floor, a housing siding, an aircraft, an automobile or a motorized vehicle, a boat, a motor, a textile material or an apparel, a medical device, an industrial device, or a component adjacent to electrical equipment; or
(d) a phase change occurs within the heat storage medium or phase change material (PCM) between about 50° C. to 350° C., between about 25° C. to 450° C., between about 5° C. to 400° C., or about 25° C., 50° C., 75° C., 100° C., 125° C., 150° C., 175° C., 100° C., 250° C., 300° C. or 350° C. or more.

21-23. (canceled)
